(19) United States
(12) Patent Application Publication
(10) Pub. No.: US 2010/0258729 A1
(43) Pub. Date: Oct. 14, 2010

(54) Infrared Repeater System

(75) Inventors: Alastair Roxburgh, Miami, FL (US); Richard Lenser, Miami, FL (US); Bill Cawlfield, Highland Ranch, CO (US)

Correspondence Address: Hogan Lovells US LLP, 1999 AVENUE OF THE STARS, SUITE 1400, LOS ANGELES, CA, 90067, US

(73) Assignee: NILES AUDIO CORPORATION, Miami, FL (US)

(21) Appl. No.: 12/422,774

(22) Filed: Apr. 13, 2009

(51) Int. Cl. G01J 5/02; G01J 5/00

(52) U.S. Cl. 250/340; 250/338.1

(57) ABSTRACT

An infrared sensor includes a photodiode receiving an infrared signal. A first amplifier is connected to the photodiode. A second amplifier is connected to the first amplifier. A DC servo is connected in a feedback loop between the output of the second amplifier and the positive side of the first amplifier. An analog-to-digital signal converter is connected to the second amplifier. An output driver is connected to the analog-to-digital signal converter. The infrared sensor may receive and retransmit an infrared signal and may be incorporated in an infrared repeater system.

### BACKGROUND OF THE INVENTION

1. Field of the Invention

This invention relates to an infrared sensor, infrared repeater system, and method of processing an infrared signal.

2. Description of Related Art

Infrared control signals are commonly used in remote control devices to control hardware from a distance. Pulse-code modulation is a known method of electrically controlling infrared light emission from an array of one or more infrared light emitting diodes (LED) housed within a remote control. Such diodes typically emit infrared light in a relatively narrow band in the range of 600-1000 nm, with 940 nm and 950 nm being the most common wavelengths for consumer electronic infrared remote controls.

Infrared remote controls are typically limited to line-of-sight applications. To solve this problem, infrared repeater units, also referred to as infrared extenders, are provided to receive, amplify, and process infrared signals emitted by an infrared remote control for re-emission to another device. An infrared repeater that can reproduce the original infrared signal can effectively traverse walls and other obstacles that would otherwise prevent line-of-sight operation using just the remote control. Infrared repeaters also increase the effective range of remote control. Alternatively, through a combination of lenses and baffles, infrared light can be focused in a narrow beam or may be spread out to flood an interior space, such as a large room, so as to render line-of-sight issues moot in some cases.

Infrared remote control signals typically consist of a series of modulated carrier bursts (herein referred to as marks) which are separated by gaps (herein referred to as spaces). An infrared message consists of a sequence of symbols coded as mark/space pairs in a manner analogous to a Morse code message. The infrared format determines the timing of mark/space pairs, and the infrared coding method determines the symbols represented by the mark/space pairs. Examples of coding symbol sets include: a simple binary set {0,1}, coded as either two different mark states (e.g., Sony format) or two different space states (e.g., NEC format); a 4-ary set {00, 01, 10, 11}, coded as mark/space pairs with four different space states (e.g., Philips RC-MM); an 8-ary set {000, 001, 010, 011, 100, 101, 110, 111}, coded as mark/space pairs with eight different space states (e.g., UEI XMP); or in general, an M-ary set {0ₙ₋₁ . . . 0₁0₀, 0ₙ₋₁ . . . 0₁1₀, 0ₙ₋₁ . . . 1₁0₀, 0ₙ₋₁ . . . 1₁1₀, . . . , 1ₙ₋₁. . . 1₁1₀} where M is a power of 2 and symbol length n=log₂M is coded as mark/space pairs with M different space states. Codes that do not enumerate all the combinations of the symbol bits, such as 3-ary, are also possible.

Longer symbols (larger n) provide a higher bit rate. For example, binary coding has a bit-rate equal to the symbol rate, 4-ary coding has a bit-rate twice the symbol rate and 16-ary coding has a bit-rate four times the symbol rate. M-ary coding (log₂M bits per symbol) can be generalized to provide a bit rate that is log₂M times the symbol rate. However, increased bit rate comes at the cost of symbol size. For each additional bit encoded in a symbol, the number (constellation) of symbols doubles in size. Therefore, the transmitted symbols are less distinct and become exponentially more prone to noise-induced errors due to a reduced time interval between symbols (guard interval). In other words, noise susceptibility, where one symbol is mistaken for another, increases when more symbols are packed into the same time interval.

FIG. 4A is a diagram of a 4-ary infrared symbol constellation. The infrared symbol constellation is limited to a single dimension due to the use of non-coherent light sources and depends on the measurement of time differences in a single scalar signal. To decode the received infrared signal, an infrared receiver measures the time interval between pairs of marks, including noise, and based on decision boundaries determines which symbol best matches the measured time.

Techniques used to increase the guard interval for radio-frequency communication systems cannot be cost-effectively implemented for infrared communication systems. For example, quadrature amplitude modulation (QAM) modulates a symbol onto the amplitude and phase of a coherent carrier signal to transmit a two-dimensional vector signal. Compared to the measurement of scalar time differences in infrared signals, QAM provides symbols that are more distinct by using fewer time or amplitude levels so as to increase separation between symbols and increase the noise margin.

FIG. 4B is a diagram of a two-dimensional symbol constellation for 4QAM, also known as quadrature phase shift keying (QPSK) coding. In QAM, each symbol is represented in the transmitter as an in-phase and quadrature (I,Q) vector pair that determines the amplitude of cosine and sine carriers. The I and Q components are summed into a single complex signal having a corresponding amplitude and phase (r, θ). The two-dimensional symbol constellation of QAM provides better noise immunity than the one-dimensional system used in infrared communications because the symbols are more distinct. The four time intervals that in RCMM infrared communications are spaced only 167 microseconds from each other (e.g. 277 μs, 444 μs, 611 μs, 778 μs), in 4QAM are divided into four widely spaced 90 degree phases. Using combinations of two very distinct amplitude values (+1, +1; +1, −1; −1, +1; −1, −1), QAM is well suited to radio-frequency communication systems.

However, a carrier generator for QAM must have low phase noise and has no practical, low cost solution for the very high frequencies (approximately 300,000 GHz) of infrared communication. Infrared communication is thus resigned to providing the low data rate methods discussed above using carrier frequencies in the tens to hundreds of kHz range.

FIG. 5 is a diagram of pulse position codes illustrating constant mark and variable space. As the symbol length increases from binary to 4-ary to 8-ary, the bit rate increases, but the number of IR bursts per message (the baud rate) remains the same. However, as the symbol length increases, the time difference between adjacent symbols decreases, thereby increasing susceptibility to noise and crosstalk. Therefore, an increase in symbol length requires a proportionate increase in timing precision in both a transmitter and receiver, as well in any repeater system. The longer the symbol length, the smaller the difference between adjacent symbols, and a greater chance of crosstalk between adjacent symbols. For these reasons, formats with more than 3 bits per symbol have yet to be used commercially.

As illustrated in FIG. 5, the length of the space starts with a special start mark S that defines the first space. Each space ends with a mark pulse M, which consists of a burst of N carrier cycles. Below the 8-ary example is the expanded mark pulse M. Coding schemes RC-MM and XMP use N=6 cycles and f_{carrier}=36 kHz and 38 kHz, respectively. Infrared formats of binary symbols (e.g., Sony and NEC) are defined as low-density codes, while infrared formats with a symbol length greater than 1 are defined as high density codes (e.g., RC-MM and XMP).

Pulse position modulation (PPM) is an example of a binary IR format. For example, a 38 kHz infrared carrier modulated by an arbitrary sequence of binary symbols with a 1 ms mark width and space timing of 1 ms (38 carrier cycles) for binary “1” and 1.5 ms (57 carrier cycles) for binary “0”. PPM is so named due to the variable space of marks (infrared bursts). Variations of this format include pulse-width modulation and bi-phase modulation. However, regardless of format, infrared remote control signals all consist of a succession of carrier bursts and gaps.

By using a fixed mark time in infrared signal formats, battery life and reliable data transfer are increased. RC-MM and XMP utilize a mark timing of 6 cycles of 36 kHz and 38 kHz infrared carrier, respectively. As a result, RC-MM and XMP are relatively compatible with each other, in terms of infrared pulse handling such that an infrared repeater system can be easily adapted to work with both. However, this relatively short mark time presents a significant challenge to infrared repeater systems. The purpose of an infrared repeater is to reproduce the signal as accurately as necessary. For low-density infrared formats (e.g., NEC), mark/space timing tolerances of ±10% are acceptable. For high-density formats such as 4-ary (e.g., RC-MM), the timing tolerance must be increased to ±2.5% and for 8-ary (e.g., XMP), the tolerance must be further increased to at least ±1.25%.

RC-MM encodes the space time into time values differing by only 6 cycles of 36 kHz carrier, at 10, 16, 22, 28 carrier cycles, thereby allowing RC-MM to encode two bits per mark/space symbol (00, 01, 10, 11, respectively). The RC-MM specification requires that these mark and space times be maintained to nominal times by 2% or better. A tolerance of 2% equals a tolerance of ¼ to ¾ cycles of 36 kHz carrier. These relatively tight tolerances are not met by conventional infrared repeater systems.

However, to accurately reproduce an infrared signal, an infrared repeater must be more stringent than specified since the RC-MM timing tolerances refer only to a single infrared transmitter and receiver combination, such as a hand-held remote directly controlling an A/V receiver, without consideration of timing distortion that an intermediate infrared repeater may impose. Simply put, the timing fidelity of an infrared repeater system of a high density code is a challenging problem. Conventional repeaters operate under conditions of a conventional 20-40 cycle burst length and are not designed to handle signals with short burst lengths such as 6 cycles.

Conventional infrared sensors also create distortion in a signal and provide a limited low frequency response resulting in a baseline shift and droop of an amplified infrared signal caused by the unipolar nature of the received infrared signal and capacitive interstage coupling. Baseline shift occurs when a burst of infrared carrier changes the signals baseline from 0 V to a value approximating the average amplitude of the carrier burst. The droop occurs as the coupling capacitor(s) discharge. The baseline shift and droop problem is manifested in the data slicer circuit that converts the amplified analog signal into a digital signal, with the creation of a “pigtail pulse”, as shown in FIG. 6. The cause of this pulse is low frequency ringing due to inadequate low frequency response in the infrared sensor. Extending the low frequency response and reducing the roll-off rate both serve to lower the “Q” of the sensor (from ˜1 in typical sensors to ˜0.5 in the present design, thereby reducing the amount of ringing when driven by a typical unipolar “impulse” in the form of a carrier-modulated burst.

Baseline shift and droop is not a significant issue with low-density infrared codes that use carrier bursts of forty pulses, since one extra pulse in forty will generally be treated as noise by the decoding hardware and software. However, baseline shift is an acute problem with high-density codes where the carrier bursts are only a few pulses long. For example, the RC-MM code uses carrier bursts six pulses long such that an extra pulse will cause significant distortion. Baseline shift/droop errors in high density codes can range from occasional decoding errors to a complete inability to decode an infrared signal. Furthermore, if the decoder utilizes envelope detection rather than pulse counting, then the detected pulse will be longer than intended, and will consequently shrink the inter-burst gap that must be preserved if the signal is to be correctly processed.

Conventional infrared repeaters provide an adequate single-pole (−6 dB/octave) high frequency response of approximately 100 kHz, but usually have a low frequency response that rolls off at too high a frequency, typically around 20 kHz (which causes the baseline shift, due to the unipolar nature of infrared signals, to have excessive droop), and at an excessive rate (−6 dB/octave per capacitor), with consequent excessive low frequency phase shift, due to the use of too many inter-stage coupling capacitors (typically 4 or 5).

As a result of the unipolar nature of infrared signals, any inter-stage coupling capacitor produces a baseline shift in the amplified infrared signal. Too many coupling capacitors together with the typical higher-than-necessary values of low roll-off frequency produce a drooping baseline shift during the received infrared burst (mark), followed by a low frequency ringing that occurs after the burst ends, and circuit equilibrium is restored. One simple way to model the ringing is to define the ‘Q’ of the sensor (Q=fₒ/Δf i.e. the sensor center modulation frequency divided by the sensor modulation bandwidth), which for the typical 25-90 kHz bandwidth case is 60 kHz/65 kHz=0.92. This represents an under-damped response, which together with the excessive low frequency phase shift gives rise to the ringing and ‘pigtail’ pulse previously mentioned.

Another way to view this is that any deviation from flatness of frequency response causes signal energy at particular frequencies to be momentarily stored in the RLC (resistor/inductor/capacitor) complex impedance equivalent of the sensor band-pass amplifier circuit, and appear shortly thereafter in the output signal as additive or subtractive distortion. The result of this distortion is the addition of extra pulses after each mark or burst of modulated infrared carrier. In low-density infrared formats where there may be twenty carrier cycles per mark, the presence of one or two extra pulses will not usually present a problem significant enough to cause an error. However, in high-density formats of six cycles per mark, one extra pulse will provide a proportionally much more significant distortion and a high likelihood of errors.

One approach to improving sensor low frequency response is to increase the values of the inter-stage coupling capacitors. The drawback to this method is the increase in settling times which slow the adaptability of the sensor to changes in the infrared interference background. Therefore, using larger inter-stage coupling capacitors to remove baseline droop and ringing solves one problem but creates the more serious problem of increased settling time.

An ideal infrared sensor provides a high gain and a completely flat frequency response extending all the way down to 0 Hz. Since it is not practical to eliminate inter-stage coupling capacitors altogether, in the present art we have found that adjusting the low frequency roll-off to approximately 1 kHz, and using only one or two coupling capacitors keeps the ‘Q’ sufficiently low that the recovery from the baseline shift droop at the end of an IR burst keeps the overshoot and ringing to an acceptable level. This reduces the sensor ‘Q’ to 49.5 kHz/99 kHz=0.5, which represents a much more damped response and a reduced tendency towards ringing.

In addition to the timing problems inherent to a high density code, the infrared signals are distorted by the environment which it travels through and increase the difficulty in maintaining mark/space timing tolerances. Wideband infrared interference sources include sunlight, compact fluorescent lights (CFLs), LCD backlights, plasma televisions, fluorescent lights and dimmed quartz halogen lamps. To minimize environmental noise, additional “redundant” information such as an additional ones-complemented version of the data, is sent in the same infrared message, or the message may simply be repeated. Electrical noise is also generated internally in repeater components such as the sensor. However, these strategies do not allow for efficient error correction, and require the infrared sensor to be redesigned for a particular environmental interference parameter. Another approach of an infrared repeater that fully decodes an infrared signal before re-transmission suffers from latency issues and the inability to handle unknown codes.

### SUMMARY OF THE INVENTION

The present invention overcome these drawbacks and reduces a DC offset error from a first amplification stage to a second amplification stage through a DC servo circuit. The present invention minimizes the output voltage offset from the second stage, thus providing DC coupling that eliminates one, or more interstage coupling capacitors and maintains a normal DC operating point. The invention provides improved low frequency response without increasing capacitive values, with consequent increased settling times through increased DC coupling. The multiplication of DC offset from one high-gain amplifier stage to another is mitigated through the DC servo circuit provided in a feedback loop. The DC coupling allows the original infrared signal to be amplified and re-transmitted accurately despite background noise including DC infrared interference such as from sunlight.

One embodiment of the invention is an infrared sensor including a photodiode receiving an infrared signal. A first amplifier is connected to the photodiode. A second amplifier is connected to the first amplifier. A DC servo is connected in a feedback loop between an output of the second amplifier and a positive side of the first amplifier. An analog-to-digital signal converter is connected to the second amplifier. An output driver is connected to the analog-to-digital signal converter.

In one implementation of the infrared sensor, the infrared signal may be coded in a high-density code such as a 4-ary code, an 8-ary code or another m-ary code. The feedback loop may include a resistor between the photodiode and the DC servo to isolate the photodiode from the DC servo. A low pass filter may be provided between the first and second amplifiers. An optical bandpass filter may receive the infrared signal before the photodiode. An automatic gain control unit may be connected to the second amplifier. A shielded, twisted pair cable may connect the photodiode to the first amplifier. The output driver may output to an infrared flasher or a twisted pair cable. The infrared sensor may process a signal with a mark timing of 6 cycles of 36 kHz or 38 kHz.

Another embodiment of the invention is an infrared repeater system in which an infrared repeater receives an infrared signal and re-transmits the infrared signal. The infrared repeater includes a photodiode receiving the infrared signal. A first amplifier is connected to the photodiode. A second amplifier is connected to the first amplifier. A DC servo is connected in a feedback loop between an output of the second amplifier and a positive side of the first amplifier. An analog-to-digital signal converter is connected to the second amplifier. The infrared repeater further includes means for re-transmitting the infrared signal.

In one implementation of the infrared repeater system, the infrared signal may be coded in a high-density code. The feedback loop may include a resistor provided between the photodiode and the DC servo to isolate the photodiode from the DC servo. The infrared sensor may process a signal with a mark timing of 6 cycles of 36 kHz or 38 kHz.

Another embodiment of the invention is a method of repeating an infrared signal. The infrared signal is received at a photodiode and is processed through an amplifier and a feedback loop between an output of the amplifier and a positive side of the amplifier. The processed infrared signal is converted into a digital signal and is output.

In one implementation of the method, the feedback loop includes components to set the gain and frequency response of the amplifier. The amplifier may include first and second amplification stages. The infrared signal may be coded in a high-density code such as a 4-ary code, an 8-ary code, or another m-ary code. The method may also include outputting the digital signal to an infrared flasher.

Another embodiment of the invention is an infrared sensor comprising a photodiode receiving an infrared signal, an amplifier connected to the photodiode and a DC servo connected in a feedback loop between an output of the amplifier and a positive side of the amplifier. An analog-to-digital signal converter, which may be 1-bit (aka data slicer) or multi-bit, is connected to the amplifier, and an output driver is connected to the analog-to-digital signal converter.

Other features and advantages of the invention will be apparent from the following detailed description, taken in conjunction with the accompanying drawings which illustrate, by way of example, various features of embodiments of the invention.

### BRIEF DESCRIPTION OF THE DRAWINGS

FIG. 1 is a block diagram of an infrared sensor according to the present invention.

FIGS. 2A and 2B are circuit diagrams of an infrared sensor system according to the present invention.

FIG. 3 is a block diagram of an infrared repeater system according to the present invention.

FIG. 4A is a diagram of a 4-ary infrared symbol constellation.

FIG. 4B is a diagram of a 4QAM symbol constellation.

FIG. 5 is a diagram of pulse position codes.

FIG. 6 is a graph of baseline shift and ringing of a conventional infrared sensor.

### DETAILED DESCRIPTION OF THE INVENTION

One embodiment of an infrared repeater device according to the present invention includes an infrared sensor 100 and at least one infrared flasher (not shown). Flashers may be attached directly over an infrared sensor window as commonly provided on televisions, audio-video receivers or amplifiers. An infrared light-tight blocker boot may optionally be used to prevent devices from responding to infrared signals other than the infrared flasher signal. Along with infrared routing, individual control of a plurality of devices sharing the same infrared codes is provided. Furthermore, a plurality of devices can also be controlled simultaneously.

An infrared repeater ideally receives and transmits an infrared signal without adding or subtracting from the original signal. However, environmental noise such as wideband infrared interference from televisions, CFLs, sunlight, etc., as well as electrical noise from light dimmers, switching power supplies, etc. will alter the received signal. Furthermore, amplification that is necessary to provide operation from distances as far as 30 feet or more also may increase the noise of the infrared signal.

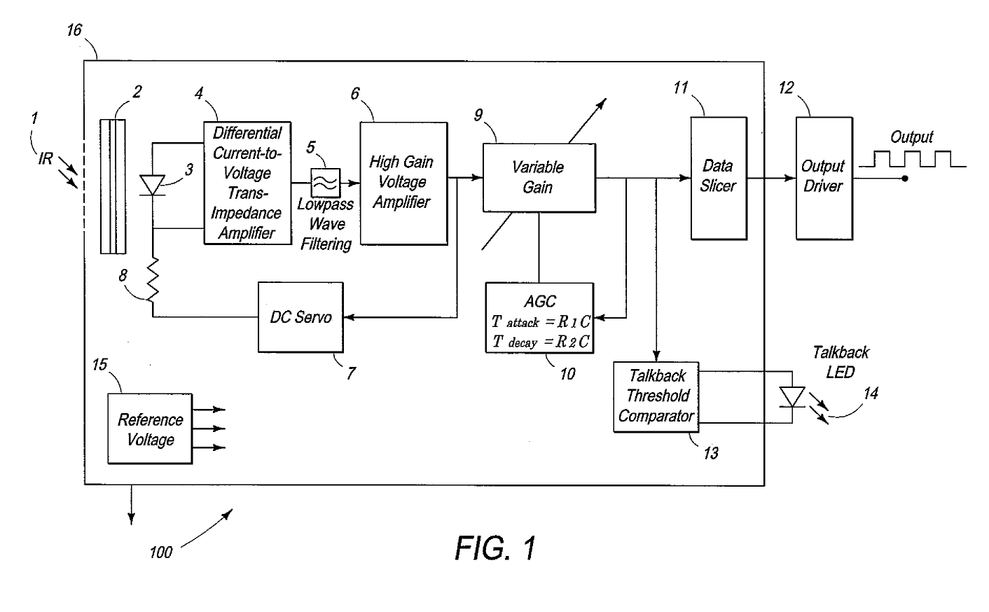

FIG. 1 is a block diagram of infrared sensor 100. Infrared signal 1 is received at sensor 100 through an optical bandpass filter 2. The filter bandpass response is set to match the spectral output of the infrared emitters, and is preferably in the range of 870 nm to 1,030 nm. Filter 2 can be an optical glass multi-layer thin film dielectric structure. After bandpass filter 2, infrared signal 1 passes through photodiode 3 before amplification by high-gain differential current-to-voltage trans-impedance amplifier stage 4. In one embodiment, photodiode 3 is a wideband Si PIN photodiode. The signal is then further amplified by high-gain voltage amplification stage 6. While amplifier stages 4 and 6 are illustrated in FIG. 1 as separate stages, the functions of amplifier stages 4 and 6 could alternatively be consolidated into a single amplifier stage.

A DC servo 7 is provided in a feedback loop to stabilize the operating point of amplification stages 4 and 6. The input to DC servo 7 is obtained from the output of amplification stage 6. The output of DC servo 7 is connected to the cathode of PIN diode 3 (non-inverting input of trans-impedance amplifier 4), via a relatively high value resistor 8 that isolates photodiode 3 from DC servo 7. Resistor 8 also sets the range of control of servo 7.

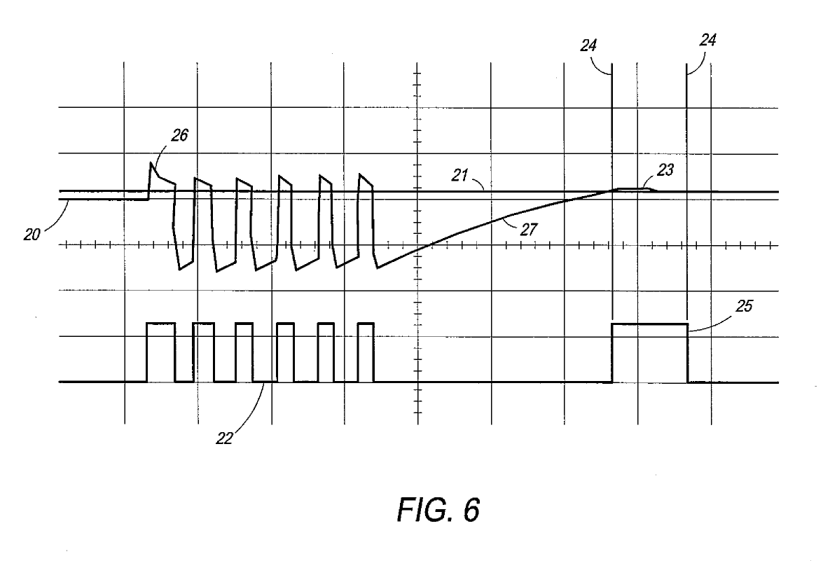

In this configuration, DC servo 7 minimizes the output voltage offset of second amplification stage 6. The DC coupling maintains a normal DC operating point in spite of steady, unmodulated infrared signals such as those produced by sunlight. The output voltage offset of the high-gain voltage amplification stage 6 is sensed by DC servo 7 and is determined relative to a reference voltage 15 so as to mathematically integrate it with a slow time constant such as one second. The DC coupling provided by DC servo circuit 7 has the primary benefit of reducing the number of coupling capacitors in the sensor. Accordingly, low frequency rolloff and phase shift is reduced. With the reduction in the number of coupling capacitors, problems arising from capacitor charging such as ringing and additional pulses at the infrared pulse trailing edge (FIG. 6) are nearly eliminated as well as keeping the wanted signal out of the noise floor.

The differential configuration of current-to-voltage trans-impedance amplifier stage 4 optionally allows sensor 100 to be configured as a two-piece sensor with photodiode 3 and optical bandpass filter 2 mounted separately from the other sensor components by a shielded, twisted pair cable connecting the two. The sensor head is thus physically minimized and provides flexibility in sensor placement to allow the processing components of sensor 100 to be easily hidden from view or configured as desired. For example, the sensor components can be provided behind a flat panel display or on a side of a wall or cabinet partition separate from photodiode 3.

Furthermore, a lowpass wave filter 5 is provided between first and second gain stages 4 and 6 to reduce the range of carrier frequencies to only those of interest, such as those under 90 kHz. An automatic noise reduction circuit, which comprises a variable gain circuit 9 and an automatic gain control (AGC) circuit 10, is a multi-time constant control circuit that prevents false triggering on infrared interference. The automatic noise reduction circuit allows an infrared remote control to transmit over moderate amounts of infrared interference. Data slicer 11 is an analog-to-digital converter that compares the processed infrared signal to a threshold voltage to convert the analog infrared signal to a digital signal. Data slicer 11 may be controlled by a microcontroller and special infrared codes such as described previously in Quintanar (US 2005/0047794).

A talkback threshold comparator 13 provides control over a talkback LED 14 and is adjusted to have a slightly higher threshold value than data slicer 11. Comparator 13 also is less precise than data slicer 11. Comparator 13 and gain control circuits 9 and 10 prevent talkback LED 14 from flickering unnecessarily. A Faraday shield 16 surrounds the entire sensor circuit 100 to prevent electrical interference from the environment and other electronic wires and devices. An output driver 12 allows sensor 100 to drive a twisted pair cable of up to approximately 100 meters to repeat or extend an infrared signal over long distances. Output driver 12 can also drive an infrared flasher for re-emission to another device.

The new IR sensor design solves a problem prevalent in all other wideband sensors, of baseline shift and droop, together with low frequency phase shift and ringing, caused by excessive use of coupling capacitors in the IR signal amplification chain, exacerbated by the unipolar nature of the IR signal. With reference to FIG. 6, which shows waveforms recorded from a widely-available infrared sensor that behaves in a way that is representative of most sensors in the market today, when receiving a burst of IR carrier (typically 36 kHz or 38 kHz), capacitor voltage droop 26 causes the signal's baseline to change from “zero” 20 to some value that only roughly approximates the average amplitude of the burst. At the end of an IR burst, such sensors recover slowly 27, exhibiting low frequency ringing and overshoot 23, attributable to excessive low frequency phase shift. This causes a problem for the following data slicer circuit, which has the job of converting the imperfect analog IR signal to a clean digital representation 22. However, every time the ringing tail of the IR burst crosses the threshold 21 of the data slicer, an extra pulse 25, referred to as a “pigtail pulse”, is created. The length of this extra pulse 25 is defined by the threshold crossing points 24.

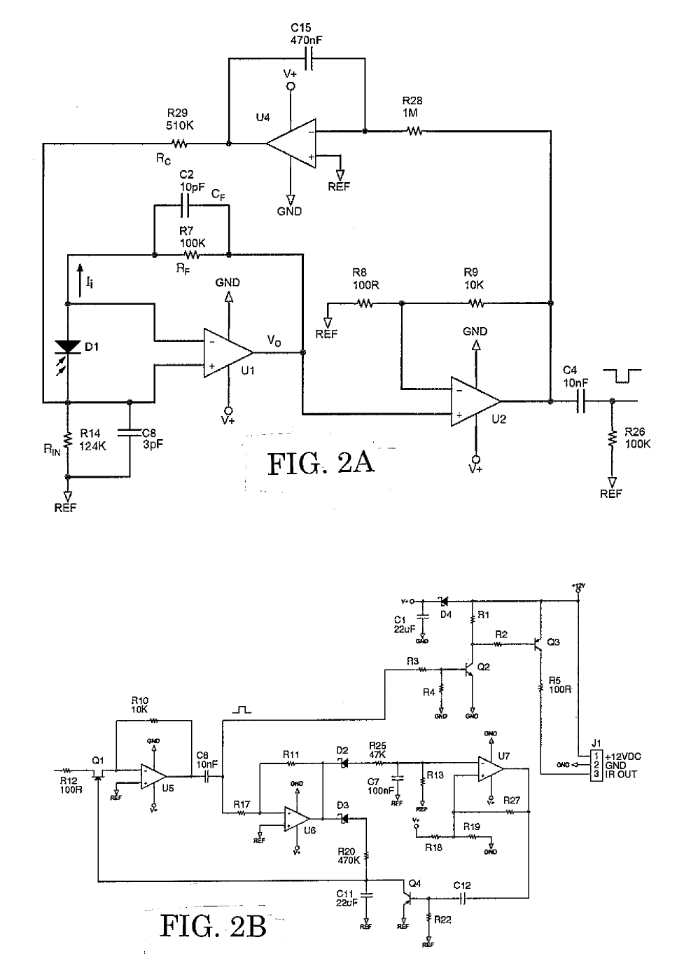

FIGS. 2A and 2B are detailed circuit diagrams of one embodiment of an infrared sensor system according to the present invention. With reference to FIG. 2A, photodiode D1 is connected in photovoltaic mode to operational amplifier U1, which is configured as a high common mode rejection (CMR) differential input transimpedance amplifier. Compared to usual transimpedance amplifier topology (which directly grounds one end of the photodiode and the non-inverting amplifier input), this configuration (see “Photodiode Amplifiers: Op Amp Solutions”, Jerald G. Graeme, McGraw-Hill, 1995) doubles the transimpedance gain while also reducing DC offset and common mode noise.

The DC gain of transimpedance amplifier U1 is Vₒ=−Iᵢ(R_{F}+R_{C}∥R_{IN}), where Iᵢ is the photodiode current, and R_{C} is the DC servo range-control resistor (described below). To balance the circuit to achieve maximum CMR, thereby optimizing rejection of noise interference, the parallel resistance of R_{C} and R_{IN} must be equal to R_{F}, which also conveniently cancels the operational amplifier's two input bias currents. Capacitor C_{F} is necessary to counteract instability due to a zero in the frequency response caused by the parallel combination of the photodiode capacitance C_{D} (typically 70 pF) and the common-mode input capacitance of the operational amplifier C_{IN} (typically several pF). Using an approximate expression for C_{F} (see “Understand and apply the transimpedance amplifier”, David Westerman, National Semiconductor Corp., Planet Analog, Aug. 8, 2007), valid for the usual case of C_{F}<<C_{IN}),

$${C}_{F} = \sqrt{\frac{{C}_{D} + {C}_{IN}}{2 \sqrt{2} π {f}_{GBW} {R}_{F}}} ,$$

where f_{GBW} is the gain bandwidth product of the operational amplifier, typically 5.5 MHz or greater (gain bandwidth product is the frequency where the open loop gain falls to 0 dB for a unity-gain-stable amplifier), the resulting C_{F} value is typically around 10 pF. A larger capacitance may be chosen to overcompensate the phase response, not only to ensure increased stability, but also to set the high frequency roll-off to the frequency range of interest. Capacitor C8, which is to R_{IN} as C_{F} is to R_{F}, is smaller than C_{F} due to the shunting effects of C_{D} and C_{IN}.

Another advantage of the differential input transimpedance amplifier topology is that is gives a convenient way to inject a DC correction signal, right at the photodiode (D1), that compensates for DC input signals such as from sunlight, as well as the front-end sensor circuitry itself, which as a result can be completely DC-coupled, thereby ensuring the low-frequency accuracy that is very critical for high-density IR signals.

Perhaps the biggest advantage of the differential input transimpedance photodiode amplifier topology is that it retains the operational amplifier's inherently high common mode rejection (CMR), which allows the photodiode to be separated from the main electronics using a shielded twisted pair cable. This allows the main electronic package to be hidden from view, reducing the size of the sensor to a package not much larger than the photodiode itself, thereby greatly reducing the visual profile of the sensor, a desirable factor in modern day living spaces.

The correction signal is generated by DC servo amplifier U4, which is configured as a relatively slow integrator. Through a DC feedback process around amplifier stages U1 and U2, the integrator is able to remove any DC signal that arises from the IR environment or the sensor front-end circuitry, ideally reducing the DC component of the output signal to zero. The strength of the correction is set by resistor R_{C}, chosen so that the largest-expected DC offset (such as from sunlight) can be completely controlled. This use of a DC servo amplifier and its connection to a modified differential input transimpedance amplifier is novel and is an advance over known art.

The DC-servo-stabilized IR signal is passed from high-gain amplifier U2 via capacitor C4 and resistor R26 to the next circuit block, which is illustrated in FIG. 2B. Variable-gain amplifier U5 of FIG. 2B is controlled according to whether the IR signal is “signal-like” (consisting mainly of short high-frequency IR bursts), or is “noise-like” (consisting mainly of typically wideband continuously-modulated IR). A simplified schematic of this latter circuit is given in FIG. 2B. Essentially, it uses an elaborate multi-time-constant, self-resetting, automatic gain control (AGC) circuit to push down continuous wideband IR interference from televisions and lighting, etc., preventing false triggering, thereby allowing IR remote controls to transmit over moderate amounts of IR interference.

With reference to FIG. 2B, the key to ambient IR noise reduction (a.k.a. Universal Noise Suppression™) is IR signal gain-control element Q1, ambient noise amplifier U6, main memory capacitor C11, and dump transistor Q4 together with a reset-decision circuit comprised of a secondary noise-memory capacitor C7, and a comparator with hysteresis, a.k.a. Schmitt trigger U7.

Amplified IR signals and wideband continuously-modulated ambient IR noise both arrive at data slicer Q2. It is the job of the noise reduction circuit to distinguish between unwanted ambient IR noise (which tends to be continuously modulated at a wide range of frequencies) from the generally, in typical practice, more powerful IR signals (which are generally also bursted), by reducing the gain of the circuit so that the noise signal no longer triggers data slicer Q2. In this way the circuit acts to push the unwanted noise component of the signal-plus-noise below the threshold of the data slicer. Ambient noise amplifier U6 amplifies the lower-level noise signal to be approximately equal in amplitude to the wanted IR signal. Main memory capacitor C11 develops a charge that increases the resistance of gain-control element Q1 until, over a time of 7 seconds or so, an equilibrium is reached where, due to the additional gain provided by U6, the overall IR gain from photodiode D1 to data slicer Q2 is reduced by a similar margin, well below the point where the noise triggers data slicer Q2.

In another embodiment, the data slicer is also adaptive, and transistor Q2 is replaced with a high-gain comparator that uses a voltage divider of gain k<1, and a lowpass filter capacitor to establish a reference point that rids the signal envelope at k×100% of full envelope amplitude.

The role of secondary memory capacitor C7 and Schmitt trigger U7 is to trigger whenever the amplitude of received wideband continuously-modulated IR noise decreases. This dumps the main memory capacitor, returning the circuit to the high-gain condition from whence it can again establish the correct signal gain by means of the resistance adjustment of Q1. Capacitor C12 must be sufficiently large that Q4 gets a long enough dump pulse when comparator U7 changes state. This prevents the circuit getting stuck at low gain when the ambient noise decreases.

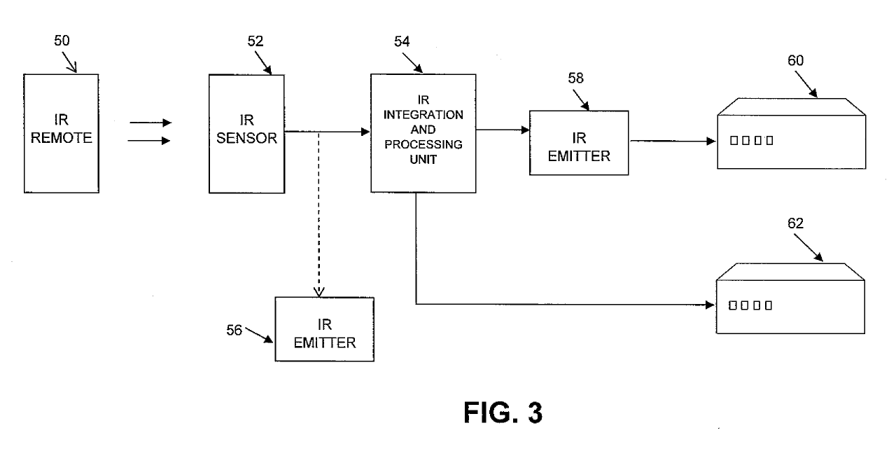

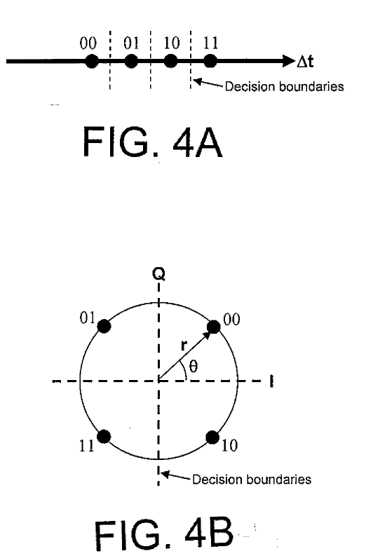

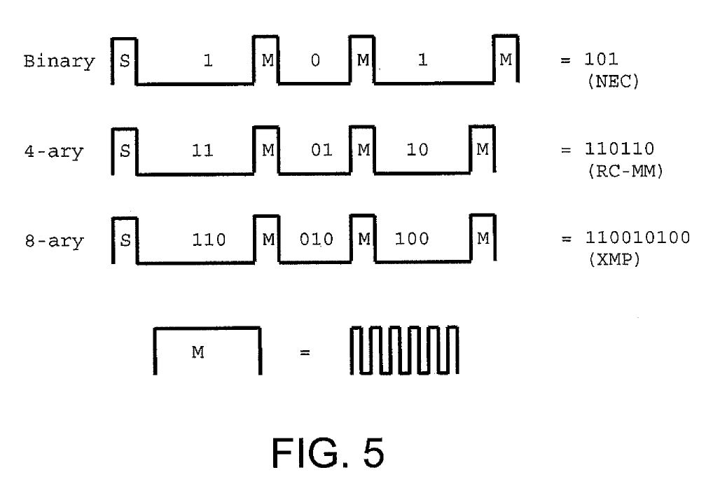

FIG. 3 illustrates an infrared repeater system incorporating an infrared sensor according to the present invention. In the infrared repeater system, an IR signal is transmitted from a control device, such as an IR remote control 50, to an IR sensor 52. IR sensor 52 is constructed in accordance with the present invention as described above, such as IR sensor 100 of FIG. 1, and may be up to 10 meters distant from IR remote 50. IR sensor 52 converts the IR signal to an electrical signal and sends it to IR integration and processing unit 54. IR integration and processing unit 54, which may be as distant as 100 meters from IR sensor 52, amplifies and/or routes the signal to an IR emitter 58. Alternatively, as illustrated by dashed-line in FIG. 3, the IR emitter may receive a signal directly from IR sensor 52. The IR emitter may be, for example, an IR flasher.

IR emitter 58, converts the electrical signal (received from either IR sensor 52 or IR integration and processing unit 54) back into an infrared signal and re-transmits the IR signal to receiving apparatus 60. In one embodiment, receiving apparatus 60 is a consumer electronics device controlled by remote 50 such as an A/V receiver, a DVD player, a television, a satellite receiver, a cable box, or the like. Alternatively, as shown in FIG. 3, the receiving apparatus 62 may have a direct connection, such as through a twisted pair cable, to IR integration and processing unit 54.

The particular embodiments of the invention described in this document should be considered illustrative, rather than restrictive. Modification to the described embodiments may be made without departing from the spirit of the invention as defined by the following claims and their equivalents.

1. An infrared sensor comprising:
a photodiode receiving an infrared signal;
a first amplifier connected to the photodiode;
a second amplifier connected to the first amplifier;
a DC servo connected in a feedback loop between an output of the second amplifier and a positive side of the first amplifier;
an analog-to-digital signal converter connected to the second amplifier; and
an output driver connected to the analog-to-digital signal converter.

2. The infrared sensor of claim 1, wherein the infrared signal is coded in a high-density code.

3. The infrared sensor of claim 2, wherein the high-density code is a 4-ary code, an 8-ary code or another m-ary code.

4. The infrared sensor of claim 1, wherein the feedback loop includes a resistor provided between the photodiode and the DC servo isolating the photodiode from the DC servo.

5. The infrared sensor of claim 1, further comprising:
a low pass filter provided between the first amplifier and the second amplifier; and
an optical bandpass filter receiving the infrared signal before the photodiode.

6. The infrared sensor of claim 1, further comprising an automatic gain control unit connected to the second amplifier.

7. The infrared sensor of claim 1, further comprising a shielded, twisted pair cable connecting the photodiode to the first amplifier.

8. The infrared sensor of claim 1, wherein the output driver outputs to one of an infrared flasher or a twisted pair cable.

9. The infrared sensor of claim 1, wherein the infrared sensor processes a signal with a mark timing of 6 cycles of 36 kHz or 38 kHz.

10. An infrared repeater system, comprising an infrared repeater receiving an infrared signal and re-transmitting the infrared signal, wherein the infrared repeater comprises:
a photodiode receiving the infrared signal;
a first amplifier connected to the photodiode;
a second amplifier connected to the first amplifier;
a DC servo connected in a feedback loop between an output of the second amplifier and a positive side of the first amplifier;
an analog-to-digital signal converter connected to the second amplifier; and
means for transmitting the infrared signal.

11. The infrared repeater system of claim 10, wherein the infrared signal is coded in a high-density code.

12. The infrared repeater system of claim 10, wherein the feedback loop includes a resistor provided between the photodiode and the DC servo isolating the photodiode from the DC servo.

13. The infrared repeater system of claim 10, wherein the infrared sensor processes a signal with a mark timing of 6 cycles of 36 kHz or 38 kHz.

14. A method of repeating an infrared signal, comprising:
receiving the infrared signal at a photodiode;
processing the infrared signal through an amplifier and a DC servo feedback loop between an output of the amplifier and a positive side of the amplifier;
converting the processed infrared signal into a digital signal; and
outputting the digital signal.

15. The method of claim 14, wherein the feedback loop includes components to set the gain and frequency response of the amplifier.

16. The method of claim 14, wherein the amplifier comprises first and second amplification stages.

17. The method of claim 14, wherein the infrared signal is coded in a high-density code.

18. The method of claim 17, wherein the high-density code is a 4-ary code, an 8-ary code, or another m-ary code.

19. The method of claim 14, further comprising:
outputting the digital signal to an infrared flasher.

20. An infrared sensor comprising:
a photodiode receiving an infrared signal;
an amplifier connected to the photodiode;
a DC servo connected in a feedback loop between an output of the amplifier and a positive side of the amplifier;
an analog-to-digital signal converter connected to the amplifier; and
an output driver connected to the analog-to-digital signal converter.
